(19) United States
(12) Patent Application Publication
(10) Pub. No.: US 2012/0263799 A1
(43) Pub. Date: Oct. 18, 2012

(54) OXYGENATED CHLORINE FOR TREATMENT OF WATER AND ITS RESPECTIVE PROCESS OF OBTAINMENT AND APPLICATION

(75) Inventor: Fernando Jorge, Valinhos (BR)

(73) Assignee: MULTCLOR QUÍMICA IMP. E EXP. LTDA., Valinhos Sao Paulo (BR)

(21) Appl. No.: 13/388,419

(22) PCT Filed: May 20, 2010
(86) PCT No.: PCT/BR2010/000176

§ 371 Date: Jul. 2, 2012

(30) Foreign Application Priority Data
Aug. 12, 2009 (BR) PI 0902987-7

(51) Int. Cl. A01N 59/00; A01P 1/00

(52) U.S. Cl. 424/615

(57) ABSTRACT

“OXYGENATED CHLORINE FOR WATER TREATMENT AND ITS RESPECTIVE PROCESS OF OBTAINMENT AND APPLICATION”, more particularly it concerns a formulation of chemical compounds whose result is the obtainment of OXYGENATED CHLORINE; a highly effective compound capable of solving several problems of water treatment, mainly of swimming pools, in the process of disinfection, oxidation and combat to both organic and inorganic chloramines. The product considerably improves the process of water treatment because it reduces the time and quantity of chemical products used, as well potentiates the efficacy of sanitizing and oxidant properties of chlorine disinfectant “chlorine”, providing then advantages inherent to its applicability, making its characteristics innovative in the field.

This present request of invention patent matter of description and claim of this report concerns an inventive solution with field of application focused on solving multiple problems of water treatment, mainly in swimming pools, in the processes of disinfection, oxidation and combat to both organic and inorganic chloramines being translated into a form of original formulation that considerably improves the process of water treatment because it reduces the time and quantity of chemical products used, as well potentiates the efficacy of sanitizing and oxidant properties of chlorine disinfectant “chlorine”, providing then advantages inherent to its applicability, making its characteristics innovative in the field.

On the other hand, the requirement of novelty and inventive activity lays on the formulation of chemical compounds whose result is the obtainment of “OXYGENATED CHLORINE”. The qualitative and quantitative formulation is summarized in:

(A) Sodium dichloro-S-triazine trione (C₃N₃O₃Cl₂Na) and/or Trichloro-S-triazine trione (C₃N₃O₃C1₃)−(35.00%-95.00%);
(B) Sodium peroxodisulphate —Na₂S₂O₈—(0.5%-40.00%);
(C) Sodium percarbonate —2Na₂CO₃. 3H₂O₂ —(0.5%-22.50%)
(D) Sodium hydrogenocarbonate —NaHCO₃—(0.5%-5.00%).

Based on the aforementioned, it is conclusive that the invention is provided with requirement of novelty, inventive activity and industrial application, accomplishing with the requirements of patentability, markedly as invention patent, as provided in the article 8 of Act 9,279.

BASES OF TECHNIQUE: in order to provide veracity to the context made explicit in the introduction, a short explanation on the existent products will be presented, where it will be possible for a technician in the area to recognize their limitative aspects, so in a further moment the technician can discourse on the advantages added with the introduction of the original compound.

Chlorine Compounds

Chlorine compounds are substances widely used as sanitizing agents in hygiene and disinfection of food, floors, tools in industrial and residential areas, in the control of diseases resulting from water and food, as well as in the treatment of water for public supply, swimming pools and spas. They have a wide range of biocide activity against bacteria, fungi and virus, and its biocide and oxidant activities are significantly increased with formation of hypochiorous acid. When chlorine is added in water the formation of hypochlorous acid (HOCl) and hydrochloric acid (HCl) occurs:

Cl₂+H₂O [symbol] HOCl+HCl

For values with pH above 4.0 the balance dislocates to the right side and io the quantity of Cl₂ that exists in the solution is small. The hypochlorous acid suffers ionization in a reaction practically instantaneous, forming hydrogen ion (H+) and hypochlorite ion (OCl—), and the grade of ionization depends on the pH and temperature. For pH values lower than 6.0 hypochlorous acid predominates, but as temperature and pH are higher, the grade of acid ionization increases and, subsequently, the concentration of hypochlorite ion. For pH values higher than 9.6 and temperature of 20° C., practically the whole hypochlorous acid suffered ionization. Hypochlorous acid and hypochlorite ion are named free chlorine. The graph below represents the variation of chlorine concentration in function of pH.

Hypochlorous acid, HOCl, has a bactericide action stronger than the hypochlorite ion OCl—. It is due to the higher permeability of cellular membrane to the covalent HOCl than to the ionic OCl—. Toxicity in relation to microorganisms is due to, but not limited to, chlorination of groups NH and SH of its proteins. To assure a higher concentration of hypochiorous acid is necessary to consider its balance of dissociation. When applying chlorine into water, the optimal pH is found in a slightly acid rate. However, pH close to 7 is used to preserve pipeline and equipments from corrosion and incrustations.

The use of buffer or buffering agent adjusts and stabilizes the pH of a solution. The function of a buffering agent is to lead an acid or alkaline solution to a certain pH and prevent from change of this pH.

The sodium hydrogenocarbonate —NaHCO₃ is widely used as buffer.

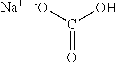

Chlorine is not only an effective disinfectant but also has proven powerful oxidant action. Thus, it is employed both in the treatment of water and in iron and manganese oxidation, removal of H₂S, control of odor, color, taste, removal of seaweeds, etc. Surprisingly, only 10% of the whole chlorine added to the water will serve to kill microorganisms. The other 90% will be used to oxide (burn) rests of microorganisms killed by disinfection, as well as other organic materials from several origins and chemical substances that can impair the quality of water such as chloramines.

Sodium dichloro-S-triazine trione: C₃HCl₂N₃O₃

Assay of active chlorine: 56%-60%

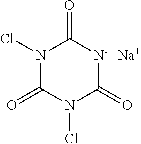

Trichloro-S-triazine trione: C₃Cl₃N₃O₃

Assay of active chlorine: 90%

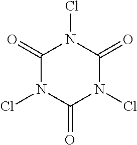

Chloramines

Combined chlorine or chloramines are formed through combination of free chlorine or hypochlorous acid (HOCl), with ammoniacal nitrogen compounds, which in the specific case of swimming pools may be expelled by bathers (sweat, urine, sun-tanning lotions) or brought by environment (tree leaves, wind). Chloramines are also considered disinfecting agents, but with disinfecting action lower and very much slower than free chlorine, causing disturbances in the processes that require immediate action of free chlorine, because it will be used to combat chloramines rather than being used against microorganisms. Chloramines may be divided into two categories: Inorganic and organic chloramines.

Inorganic chloramines

Inorganic chloramines result from chemical reaction of hypochlorous acid (HOCl) with ammoniacal compounds (NH₃). The most common types of chloramines found in a swimming pool are: monochioramines (NH₂Cl), dichloramines (NHCl₂) and trichloramines (NCl₃). Its reactions may, be represented:

Ammonia+hypochlorous acid→Monochloramine+Water

NH₃+HOCl→NH₂Cl+H₂O

Monochloramines may react with more hypochlorous acid and form dichloramines.

Monochloramine+hypochlorous acid→Dichloramine+Water

NH₂Cl+HOCl→NHCl₂+H₂O

Finally, dichloramines may react with hypochlorous acid to form trichloramines

Dichloramine+hypochlorous acid→Trichloramine+Water

NHCl₂+HOCl→NCl₃+H₂O. The type of chloramine produced will depend on the pH.

Organic Chloramines

Organic chloramines are resulting from chemical reaction of hypochlorous acid (HOCI) with nitrogen organic compounds, such as proteins.

Its reactions may be represented:

R—NH₂+HOCl→R—NHCl+H₂O, where R=Organic radical.

Impact of Chloramines in the Quality of Water

Chloramines generally are the cause of that called “strong smell of chlorine in the water”, respiratory problems and irritation of eyes and mucous membranes of swimming pool users. These features are found when concentrations of combined chlorine or chloramines are higher than 0.3 ppm. To determine chloramines concentration two different types of tests are used: The first one that uses DPD methodology (N,N-diethyl-p-phenylenediamine; colorimetric test) that measures the “free chlorine” or amount of hypochlorous acid (HOCl) and the second test that measures the “total chlorine” that uses OT (ortho-tolidine) methodology. The combined chlorine is calculated by the difference found between the “free chlorine” and “total chlorine”.

Combined chlorine=Total chlorine−free chlorine

Relative Error and Standard Deviation between both methods of analysis of total chlorine and free chlorine. The table below transcribes data referent to studies on the OTA and DPD methods.

is observed that DPD method has lower relative error and lower standard deviation.

| | Concentration of | | | | |
|---|---|---|---|---|---|
| | Residual Chlorine | | | Relative | Relative |
| | Free | Total | Number of | Standard | Error |
| Method | (mg/L) | (mg/L) | laboratories | Deviation | (%) |
| OT | 800 | — | 15 | 64.6 | 42.5 |
| | — | 640 | 17 | 37.3 | 20.2 |
| | — | 1830 | 18 | 31.9 | 41.4 |
| OTA | 800 | — | 20 | 52.4 | 42.3 |
| | — | 640 | 21 | 28.0 | 14.2 |
| | — | 1830 | 21 | 35.0 | 49.0 |
| DPD | 980 | — | 26 | 20.7 | 15.6 |
| | — | 860 | 26 | 27.6 | 15.6 |

Elimination of Chloramines with Chlorine Compounds

For removal of chloramines it is used the process called “Break point of chlorination”, “over-chlorination of shock” or still “oxidation of shock”. During this process extra dosages of chlorine are added until the level of hypochlorous acid (HOCl) becomes high enough to convert chloramines in nitrogen gas (N₂), HCl and water. The required proportion is 10:1. For a mass of water that contains 0.5 ppm of chloramines, a dosage of 5 ppm of chlorine will be enough to bring the free chlorine back to its best and more effective disinfecting concentration. The calculation of extra chlorine quantity to be used in the over-chlorination must be accurate to avoid excess or insufficiency. The excess of chlorine may cause prejudice to health and equipments, in addition to stimulation of formation of more chloramines. If the quantity is not enough, the free chlorine available after oxidation will be decreased, occasioning low disinfecting action and subsequently the appearance of new associated problems.

Elimination of Chloramines with Non-Chlorine Compounds

Non-chlorine oxidant products (peroxides, persulphates, perborates, percarbonates and other oxygenated compounds) are effective alternatives in the combat to chloramines and in the elimination of microorganisms killed during the disinfection process. Due to the high assay of active oxygen of these products, the oxidation of chloramines is almost forty times stronger and faster than that performed from hypochlorous acid (HOCl). The advantages of oxidation without chlorine include the fact of no addition of any extra source of (HOCl) for production of new chloramines and the efficacy of sanitizing product will be multiplied with no exaggerated increase of chlorine level.

Without addition of more chlorine for process of oxidation, the remaining free chlorine may better perform its important role of disinfecting agent. The s versatility in the use of oxygenated compounds allows application both in preventive and corrective manner, significantly improving the control of chloramines and disinfection process.

Oxidation by Active Oxygen

In the process of oxidation using chlorine compounds, the atom that suffers reduction is Cl (from 1+, in the CIO—, to −1, in the Cl—). In the case of oxygenated compounds, the oxygen goes from O₂⁻² to O⁻²+O⁰, the resulting oxygen, or [O] and this [O] is the atom that suffers reduction, in general to O⁻², oxidizing other elements.

Sodium Percarbonate and Sodium Peroxodisulphate

Sodium percarbonate is also known as solid hydrogen peroxide. This material presented in the form of white granules is result of addition of sodium carbonate with hydrogen peroxide, its formulation is 2Na₂CO₃. 3H₂O₂.

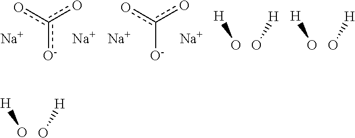

Sodium percarbonate has high assay of active oxygen (13.00%) and optimal solubility in water. When in contact with water it releases hydrogen peroxide H₂O₂ and sodium carbonate Na₂CO₃.

2Na₂CO₃.2H₂O₂→2Na₂CO₃+3 H₂O₂

H₂O₂ is dissolved in water as described:

H₂O₂→H++HOO—2HOO—→OO₂↑+2OH—

In accordance with both equations, the HOO— ion has powerful oxidant function.

The hydrogen peroxide in fact is the oxidant ingredient when in contact with water it breaks into active oxygen and water. The beauty of this system consists of observing that the granulated sodium percarbonate is considered stable when in encapsulated form and co-materials (sodium carbonate and water) are innocuous after its activation. Sodium percarbonate is typically considered unstable material and because of that its encapsulated or coated form allows to associate it with other materials.

Sodium peroxodisulphate as well as sodium percarbonate is a powerful oxidant agent. Its formulation Na₂S₂O₈ and has (6.5%) of active oxygen.

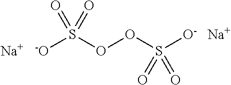

Representation of sodium peroxodisulphate dissolution in water:

NaS₂O₈+H₂O→2Na++S₂O₈²⁻

Proposal of Invention

Chlorine+Oxygen

The applicant, after several studies, extensive research of field and in laboratory, has developed in an intelligent and innovative way the product “OXYGENATED CHLORINE”, a result of specific process that collects chlorine compounds, oxygenated compounds, buffering agent, control of temperature, pH and moisture, in addition to reconcile time and mechanic action:

Chlorine compounds:

Sodium dichloro-S-triazine trione (C₃HCl₂N₃O₃)
Trichloro-S-triazine trione (C₃Cl₃N₃O₃).

Oxygenated compounds:

Sodium percarbonate Na₂CO₃.
Sodium peroxodisulphate (Na₂S₂O₈)

Buffering agent:

Sodium hydrogencarbonate—NaHCO₃

Through original process of production and stabilization, the applicant made possible what until now was considered impracticable by the market: the union of oxidants predominantly antagonist and with higher risk of reactions among each other with extremely high potential of both disinfecting and oxidant efficiency:

The “OXYGENATED CHLORINE” is capable of gathering features of disinfection and oxidation in a sole product with significant advantages. With addition of oxygen, the oxidant and disinfecting power of chlorine is considerably potentiated. As the oxidation power of oxygen is about forty times stronger and faster than the chlorine (HOCl)—hypochlorous acid, at least 50% of this efficiency is transferred to the “OXYGENATED CHLORINE” compound. The proportion of active oxygen added to chlorine will determine the coefficient of efficiency and potency of the new compound.

Benefits of OXYGENATED CHLORINE in the Treatment of Water of Swimming Pools

The use of disinfectants to oxide organic contaminants reduces a lot the efficacy of sanitization.

The increase of organic contamination level increases the consumption of disinfectant for oxidation, reducing then the availability for disinfection. Without regular oxidation, there is accumulation of substances eliminated by bathers and other organic contaminants. Thus, there is more potential of consumption of chemical sanitizing agents than that provided. As consequence, the quality of water begins to deteriorate, presenting growing of seaweeds or muddy and opaque water. Above all, it is difficult to keep the proper protection against diseases and infection caused by microorganisms, putting health bather at risk.

Sanitization is the use of disinfectants to eliminate from water of swimming pools and spas the pathogenic organisms including bacteria, virus and other microorganisms causing diseases and infections. Effective sanitization protects bathers from these dangers. Oxidation (application) involves addition of chemical oxidants in water of swimming pools and spas to destroy, by heating, organic contamination from several origins:

Bathers let in water a large quantity of substances eliminated by sweating and body oils, cosmetic products, sunscreens and sun-tanning lotions.

Climatic conditions such as wind and rain bring many other contaminants. These contaminants accumulate and increase the use of disinfectant available. Regular oxidation associated to sanitization keeps the water clear and transparent, free of microorganisms that cause diseases and infections. OXYGENATED CHLORINE may be added to swimming pool during the day or at night. After a short period of time that allows proper mixture and dispersion throughout the swimming pool, the bath is allowed. There is no need of agitation; the “OXYGENATED CHLORINE” is completely soluble in water and has fast dissolution.
Maximal efficacy of disinfectant by oxidation and elimination of remaining contaminants.
Does not produce chloramines or form irritant odors.
Restores limpidity and clarity.
Slight for swimming pool surfaces with fast and total dissolution and does not clear or discolor vinyl covertures or painted surfaces.
Does not increase calcium hardness or increase the levels of cyanuric acid stabilization.
Easy handling; it is just to uniformly spread on the swimming pool surface with the filter working, assuring homogenization and complete circulation.

### DETAILED DESCRIPTION OF THE INVENTION

To consolidate the “OXYGENATED CHLORINE FOR TREATMENT OF WATER AND ITS RESPECTIVE PROCESS OF OBTAINMENT AND APPLICATION”, the applicant presents in the following paragraphs the formulation, production io process, and application by means of examples, highlighting that they do not intend to limit the invention scope, but this one is limited only to the claims.

Particularly it concerns a formulation of chemical compounds whose result is the obtainment of “OXYGENATED CHLORINE”; a highly effective compound capable of solving several problems of water treatment, mainly of swimming pools, in the process of disinfection, oxidation and combat to both organic and inorganic chloramines.

The qualitative and quantitative formulation is summarized in:

(A) Sodium dichloro-S-triazine trione (C₃N₃O₃Cl₂Na) and/or Trichloro-S-triazine trione (C₃N₃O₃Cl₃)−(35.00%-95.00%);
(B) Sodium peroxodisulphate —Na₂S₂O₈—(0.5%-40.00%);
(C) Sodium percarbonate —2Na₂CO₃. 3H₂O₂—(0.5% −22.50%)
(D) Sodium hydrogenocarbonate —NaHCO₃—(0.5% −5.00%).

The production process comprehends the following steps:

1) Use mixer of dry products for reaction and control of material homogenization.

2) Certify that the order and respective quantities are respected in accordance with the formula.

3) Add at first the Sodium dichloro-S-triazine trione and/or Trichloro-S-triazine trione

4) After interval of (3 to 8 minutes) of mixer working, analyze temperature and moisture conditions.

5) The temperature shall be between 27° C. and 31° C.

6) The internal moisture of reactor shall be lower than 0.01%.

7) Add sodium hydrogenocarbonate and homogenize in interval (from 6 to 14 minutes) and observe if the temperature and moisture are within safety ranges.

8) The pH shall be balanced so that it is not lower than 5.5 or higher than 6.2.

9) Add sodium peroxodisulphate and homogenize for time no lower than 7 minutes.

10) Add sodium peroxodisulphate and homogenize for time of (09 to 17) minutes and observe if the temperature and moisture are within safety ranges.

11) Mixture shall be transferred through proper, automatic transference equipment, preferably with device of worm screw, made in steel specially projected for this type of product and totally sealed.

12) The compound shall be immediately packed, in automatic packing machine, with no handling or absorption of environment moisture, impairing quality and stability of the product.

The process requires specific care to assure integrity and safety of active principles.

The quantities described in the formulation vary in accordance with parameters of intended use and efficacy.

There are physical and chemical factors in the active substances of each component that limit the formulation to certain grades of safety and applicability.

The physical structure of reactor/mixer must be specially made so that there is the lowest risk as possible of contamination of materials, as well as longer shelf life to equipments. The worm screw of material transportation must be made with Stainless Steel 316L and Hastelloy C276 and internal covering with polyester ink (NEMA 4X, IP67). The packing chamber must have insulation based on special resin capable of keeping temperature and abrasivity of oxidants. The control of temperature and moisture shall be performed through electronic measuring equipment, immersion thermometer, evaporators and exhaust fans connected to reactor tower.

The mixture shall be transferred through proper, automatic transference equipment, preferably with device of worm screw made in steel specially projected for this type of product and totally sealed.

The compound shall be immediately packed, in automatic packing machine, with no handling or absorption of environment moisture, impairing quality and stability of the product.

Application

“OXYGENATED CHLORINE” may be used in the same manner and with the same applicability of 100% chlorine compounds available today. Indeed, its differentiation is in the quantity employed (mg/L) to reach the same result of disinfection and oxidation. When adding active oxygen in the chlorine compound, its efficiency will be potentiated. Although the quantity of active chlorine (%) is partially replaced by active oxygen (%), there will be substantial increment in the power of disinfection and oxidation of active substances in the compound, as shown in the graph below:

Characteristics of Invention Efficacy

The efficacy of OXYGENATED CHLORINE may be shown through comparative calculation of active substances of chlorine compounds X OXYGENATED CHLORINE, as well as by laboratorial tests certified in attached document:
Comparative calculation of active substances of chlorine compounds X OXYGENATED CHLORINE

| 100% of Sodium dichloro-S-triazine | 100% of Sodium trichloro-S-triazine |
|---|---|
| trione = 60% active chlorine | trione = 90% active chlorine |
| 1 kg of product has 0.600 grams of | 1 kg of product has 0.900 grams of |
| active chlorine | active chlorine |
| 1 g of product per m³ of water = 0.60 ppm | 1 g of product per m³ of water = 0.90 ppm |
| of active substances | ppm of active substances |
| 1.67 g = 1 ppm of active chlorine per | 1.11 g = 1 ppm of active chlorine per |
| m³ | m³ |
| 100% of OXYGENATED CHLORINE | 100% of OXYGENATED CHLORINE |
| Sodium dichloro-S-triazine trione = | Trichloro-S-triazine trione = 73.04% |
| 48.69% active chlorine + 1.00% of | active chlorine + 1.00% of active |
| active oxygen in the formula | chlorine in the formula |
| 1 kg of product has 0.487 grams of | 1 kg of product has 0.730 grams of |
| active chlorine | active chlorine |
| 1 kg of product has = 0.010 grams of | 1 kg of product has = 0.010 grams of |
| active ◯ | active ◯ |
| (*) 0.100 × 40 + 2 = 0.200 grams of | (*) 0.100 × 40 + 2 = 0.200 grams of |
| active ◯ | active ◯ |
| (**) 1 kg of product has 0.687 grams | (**) 1 kg of product has 0.930 grams |
| of active substances | of active substances |
| 1 g of product per m³ of water = 0.68 ppm of | 1 g of product per m³ of water = 0.93 ppm |
| active substances | of active substances |
| 1.46 g = 1 ppm of active substances | 1.07 g = 1 ppm of active substances |
| per m³ | per m³ |
| Relative potential of OXYGENATED | Relative potential of OXYGENATED |
| CHLORINE = +14.48%, if compared | CHLORINE = +3.38%, if compared to |
| to Sodium dichloro-S-triazine trione | Sodium trichloro-S-triazine trione |
| 100% | 100% |

(*) 1 gram of Oxygen in water is equal to 40 times the power of oxidation of active chlorine = 40 g; but this value is divided by 2, so that the matrix of chlorine power distribution can be balanced: 90% for oxidation and 10% for disinfection.
(**) Active substances equivalent to the new compound, considering that with the Oxygen performance the other active substances will be potentiated.
(***) Percent relation of gain or loss of efficiency between chlorine compound 100% and the same compound with addition of active Oxygen in the formulation.

$$\% relative potential of OXYGENATED CHLORINE = ( \frac{\begin{matrix}\% of active chlorine in the formula + \\ ( \% active oxygen in the formula \times 20 )\end{matrix}}{\begin{matrix}\% of chlorine sodium dichloro \text{-} S \text{-} triazin e trione 100 \% \\ or trichloro \text{-} S \text{-} tr iazine trione 100 \%\end{matrix}} ) \qquad Equation$$

### EXAMPLES

### Example 1

% Active chlorine in the formula=44.54%

% Active oxygen in the formula=1.50%

% Chlorine of sodium dichloro-S-triazine trione 100% =60%

$$\% Relative potential of OXYGENATED CHLORINE = ( \frac{44.54 \% + ( 1.5 \% \times 20 )}{60 \%} ) - 1 \times 100$$

$$\% Relative potential of OXYGENATED CHLORINE = ( \frac{74.54 \%}{60 \%} ) - 1 \times 100$$

$$\% Relative potential of OXYGENATED CHLORINE = 24.23 \%$$

Analysis: The result shows that “OXYGENATED CHLORINE” is 24.32% more powerful than the chlorine compound based on sodium dichloro-S-triazine trione 100%, although in its formulation there is only 44.54% of active chlorine.

### Example 2

% Active chlorine in the formula −54.35%

% Active oxygen in the formula=2.50%

% Chlorine of sodium trichloro-S-triazine trione 100% =90%

$$\% Relative potential of OXYGENATED CHLORINE = ( \frac{54.35 \% + 2.5 \% \times 20 )}{90 \%} ) - 1 \times 100$$

$$\% Relative potential of OXYGENATED CHLORINE = ( \frac{104.35 \%}{90 \%} ) - 1 \times 100$$

$$\% Relative potential of OXYGENATED CHLORINE = 15.94 \%$$

Analysis: The result shows that “OXYGENATED CHLORINE” is 15.94% more powerful than the chlorine compound based on sodium trichloro-S-triazine trione 100%, although in its formulation there is only 54.35% of active chlorine.

Determination of active oxygen in the compound OXYGENATED CHLORINE:

Materials:
Spatula
250-mL Erlenmeyer
100-mL Becker
50-mL volumetric burette
50-mL cylinder

Equipments:
Analytical balance
Magnetic mixer

Reagent/Solutions:
Solution of Sulfuric Acid (H₂SO₄) 5 N
Solution of Potassium Permanganate (KMnO₄) 0.1 N
Distilled water

Sample preparation:

Weight in analytical balance 0.5 g of sample in a 250-mL Erlenmeyer.

Add 40 mL of sulfuric acid solution 5 N

Wash the Erlenmeyer wall with distilled water.

Titration:

In a 50-mL burette the titration reagent is added (potassium permanganate 0.1 N), with support of a 100-mL Becker, set it to zero taking care to avoid formation of possible bubbles in the body and in the extremity (regulator/valve), after setting to zero, start the titration under agitation (manual or magnetic mixer) controlling the outflow velocity to not pass the toning point. Continue the titration slowly and under agitation until toning from transparent (initial color) to rink (final color) and record the spent volume.

$$Calculation \text{:}$$

$$\% total active oxygen = \frac{( V \times Fc \times 2 \times 100 ) / 2.5}{M \times 1000}$$

$$Where \text{:}$$

$$V \text{:} Volume of potassium permanganate solution 0.1 N spent in titration$$

$$Fc = Correction factor of titration solution . \\ 2 \text{:} Quantity in gram of active {O}_{2} mass correspondent to reaction = 0.125 mol of {O}_{2} . \\ 100 and 1000 \text{:} Conversion factors of equation . \\ 2.5 \text{:} Correction of equation ( formula ) for use of potassium permanganate . \\ M \text{:} Sample mass .$$

In a declared chemical composition (%): Sodium dichloro-S-triazine trione: 50; co-adjuvant−sodium chloride: 17; compound of sodium peroxodisulphate: 23; polichloride of polymerized aluminum: 10 in the quantity of 2000 g with the purpose of evaluating the algicide and/or algistatic efficacy the applicant performed trial tests proving the efficacy of the product in seaweeds Pseudokirchineriella subcaptata in the operational unit of Laboratórios Ecolyzer Ltda.

With a declared chemical composition (%): Trichloro-S-triazine trione: 20; Sodium dichloro-S-triazine trione: 20; co-adjuvant−sodium chloride: 42; compound of sodium peroxodisulphate: 23; polichloride of polymerized aluminum: 3 in the quantity of 2000 g with granulated sample with the purpose of evaluating the algicide and/or algistatic efficacy the applicant performed trial tests proving the efficacy of the product in seaweeds Pseudokirchineriella subcaptata in the operational unit of Laboratórios Ecolyzer Ltda.

Other declared chemical composition (%): Trichloro-S-triazine trione: 95; Cupric sulfate pentahydrate: 2; compounds of sodium peroxodisulphate: 1; polichloride of polymerized aluminum: 2 in the quantity of 800 g with sample in tablets with the purpose of determining thermal stability and of air, the applicant performed trial tests proving the bactericide action upon specific strains of Escherichia coli and Enterococcus faecium in the operational unit of Laboratórios Ecolyzer Ltda.

It is verified by what has been described and illustrated that the “OXYGENATED CHLORINE FOR WATER TREATMENT AND ITS RESPECTIVE PROCESS OF OBTAINMENT AND APPLICATION” herein claimed meets the rules that govern the invention patent in the light of Industrial Property Act, deserving, in accordance with has been exposed herein and as a consequence, the respective privilege.

1) “OXYGENATED CHLORINE FOR WATER TREATMENT” concerns a formulation of chemical compounds for water treatment, mainly of swimming pools, in the processes of disinfection, oxidation and combat to both organic and inorganic chloramines WHERE
(A) Sodium dichloro-S-triazine trione (C₃N₃O₃Cl₂Na) and/or Trichloro-S-triazine trione (C₃N₃O₃Cl₃)−(35.00% −95.00%);
(B) Sodium peroxodisulphate —Na₂S₂O₈—(0.5% −40.00%);
(C) Sodium percarbonate —2Na₂CO₃. 3H₂O₂—(0.5% −22.50%)
(D) Sodium hydrogenocarbonate —NaHCO₃—(0.5% −5.00%).

2) “OXYGENATED CHLORINE FOR WATER TREATMENT”, in accordance with claim 1 WHERE it adds active oxygen in the chlorine compound.

3) “OXYGENATED CHLORINE FOR WATER TREATMENT”, in accordance with claim 1 or 2 in a performance WHERE
% Active chlorine in the formula=44.54%
% Active oxygen in the formula=1.50%
% Chlorine of sodium dichloro-S-triazine trione 100% =60%

4) “OXYGENATED CHLORINE FOR WATER TREATMENT”, in accordance with claim 1 or 2 in a performance WHERE
% Active chlorine in the formula=54.35%
% Active oxygen in the formula=2.50%
% Chlorine of sodium trichloro-S-triazine trione 100% =90%

5) “PROCESS OF OBTAINMENT AND APPLICATION” WHERE it comprehends the following steps:
Use mixer of dry products for reaction and control of material homogenization;
order and respective quantities are respected in accordance with the formula;
Add at first the Sodium dichloro-S-triazine trione and/or Trichloro-S-triazine trione;
Interval of (3 to 8 minutes) of mixer working, analyze temperature and moisture conditions;
The temperature shall be between 27° C. and 31° C.;
The internal moisture of reactor shall be lower than 0.01%;
Add sodium hydrogenocarbonate and homogenize by interval (from 6 to 14 minutes) and observe if the temperature and moisture are within safety ranges;
The pH shall be balanced so that it is not lower than 5.5 or higher than 6.2;
Add sodium peroxodisulphate and homogenize for time no lower than 7 minutes;
Add sodium peroxodisulphate and homogenize for time from (09 to 17) minutes and observe if the temperature and moisture are within safety ranges.

6) “OXYGENATED CHLORINE FOR WATER TREATMENT AND ITS RESPECTIVE PROCESS OF OBTAINMENT AND APPLICATION”, in accordance with claim 1 or 5 WHERE physical structure of reactor/mixer must be with worm screw of material transportation, it must be preferably made with Stainless Steel 316L and Hastelloy C276 and internal covering with polyester ink (NEMA 4X, IP67); the packing chamber must have insulation based on special resin capable of keeping temperature and abrasivity of oxidants; the control of temperature and moisture shall be performed through electronic measuring equipment, immersion thermometer, evaporators and exhaust fans connected to reactor tower.

7) “OXYGENATED CHLORINE FOR WATER TREATMENT”, in accordance with claim 1, where in a form of shown performance of mixture it is CHARACTERIZED IN THAT declared chemical composition (%): Sodium dichloro-S-triazine trione: 50; co-adjuvant−sodium chloride: 17; compound of sodium peroxodisulphate: 23; polichloride of polymerized aluminum: 10.

8) “OXYGENATED CHLORINE FOR WATER TREATMENT”, in accordance with claim 1, where in a form of shown performance of mixture it is CHARACTERIZED IN THAT declared chemical composition (%): Trichloro-S-triazine trione: 20; Sodium dichloro-S-triazine trione: 20; co-adjuvant−sodium chloride: 42; compound of sodium peroxodisulphate: 15; polichloride of polymerized aluminum: 3 with granulated sample.

9) “OXYGENATED CHLORINE FOR WATER TREATMENT”, in accordance with claim 1, where in a form of shown performance of mixture it is CHARACTERIZED IN THAT declared chemical composition (%): Trichloro-S-triazine trione: 95; Cupric sulfate pentahydrate: 2; compounds of sodium peroxodisulphate: 1; polichloride of polymerized aluminum: 2 with sample in tablets.
